(19) United States
(12) Patent Application Publication
(10) Pub. No.: US 2011/0253762 A1
(43) Pub. Date: Oct. 20, 2011

(54) TISSUE CUTTING DEVICE

(76) Inventor: KE-TA WANG, Taichung City (TW)

(21) Appl. No.: 12/777,242

(22) Filed: May 10, 2010

(30) Foreign Application Priority Data
Apr. 16, 2010 (TW) 099206963

(51) Int. Cl. B26F 3/02

(52) U.S. Cl. 225/77

(57) ABSTRACT

A tissue cutting device is for cutting a tissue roll having a rolling section and an extension section. The rolling section is disposed about a core. The extension section is extended from one end of the rolling section and has a distal end. The tissue cutting device includes an abutting element and a lever element. The lever element is pivotable and has a first section and a section. A distal end of the first section is a first end. A distal end of the second section is a second end. A gap is defined between the abutting element and the first end for the extension section to extend therethrough. The extension section is divided into a preserving section and a serving section. The preserving section is between the gap and the rolling section. The serving section is between the gap and the distal end of the extension section.

### BACKGROUND OF THE INVENTION

1. Field of the Invention

The present invention relates to a tissue cutting device for cutting a tissue roll.

2. Description of the Prior Art

A conventional tissue cutting device is as disclosed in TW 572744. More specifically, the tissue is designed to pass through a first roller 24 and a second roller 25, and the tissue is therefore clamped therebetween by the weight of the second roller 25. The tissue cutting device includes a lever mechanism 17. A front portion of the lever mechanism 17 can prevent the tissue from contacting the cutting portion 20 at a natural state. When the user wants to cut the tissue by the cutting portion 20, the weight of the second roller 25 is not sufficient to stop the tissue from being further pulled out. As a result, the tissue keeps running out from the rollers 24 and 25, and the user is really disturbed.

The present invention is, therefore, arisen to obviate or at least mitigate the above mentioned disadvantages.

### SUMMARY OF THE INVENTION

The main object of the present invention is to provide a tissue cutting device that can adequately stop the tissue from being further pulled as the user is cutting the tissue.

To achieve the above and other objects, a tissue cutting device of the present invention is for cutting a tissue roll having a rolling section and an extension section. The rolling section is disposed about a core. The extension section is extended from one end of the rolling section and has a distal end. The tissue cutting device includes an abutting element and a lever element. The lever element is pivotable about an axis and has a first section and a second section. The second section connects to the first section at the axis. A distal end of the first section is a first end, and a distal end of the second section is a second end. A gap is defined between the abutting element and the first end for the extension section of the tissue roll to extend therethrough. The extension section is therefore divided into a preserving section and a serving section. The preserving section is between the gap and the rolling section of the tissue roll, and the serving section is between the gap and the distal end of the extension section.

When the serving section applies force to the second end so as to rotate the second end in a rotary direction, the first end correspondingly rotates in the rotary direction until the first end abuts against the abutting element. As such, the extension section of the tissue roll is clamped between the first end and the abutting element.

On the other hand, when the serving section does not apply force to the second end, the extension section is free to pass through the gap.

Thereby, the extension section can be tightly clamped between the first end and the abutting element when the tissue is to be cut, thus facilitate the cutting procedure.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a tissue cutting device of the present invention;

FIG. 2 is a perspective drawing showing a tissue cutting device of the present invention;

FIG. 3 is a lateral view showing a tissue cutting device of the present invention;

FIG. 4 is a profile showing a tissue cutting device of the present invention;

FIG. 4A is a partial enlargement of FIG. 4;

FIG. 5 is a profile showing a tissue cutting device of the present invention, in which the tissue applies force on the second end of the lever element;

FIG. 5A is a partial enlargement of FIG. 5;

FIG. 6 is a perspective drawing showing another rack of the present invention;

FIG. 7 is a profile showing another tissue cutting device of the present invention;

FIG. 8 is a front view showing yet another tissue cutting device of the present invention;

FIG. 9 is a perspective drawing showing yet another tissue cutting device of the present invention;

FIG. 10 is a perspective drawing showing yet another tissue cutting device of the present invention in combination with a conventional tissue holder;

FIG. 11 is a profile showing yet another tissue cutting device of the present invention in combination with a conventional tissue holder.

### DETAILED DESCRIPTION OF THE PREFERRED EMBODIMENTS

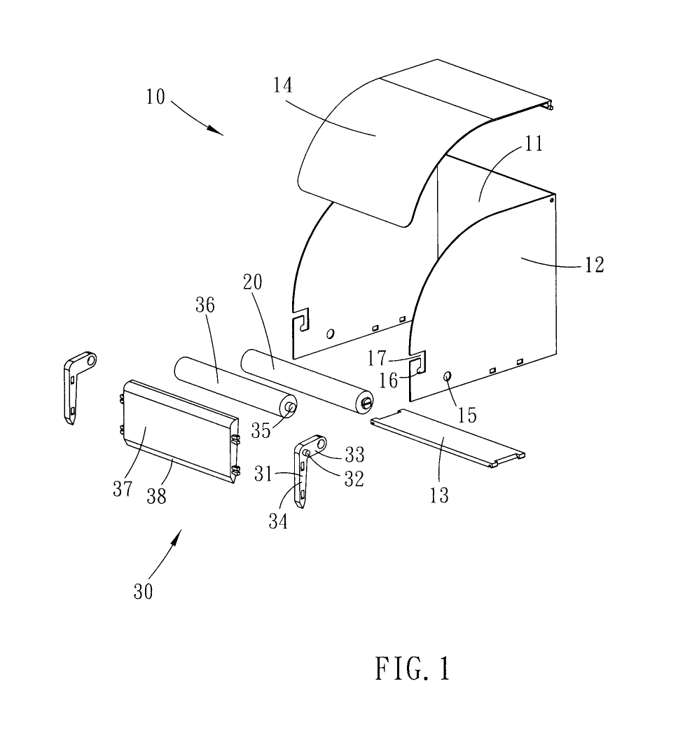

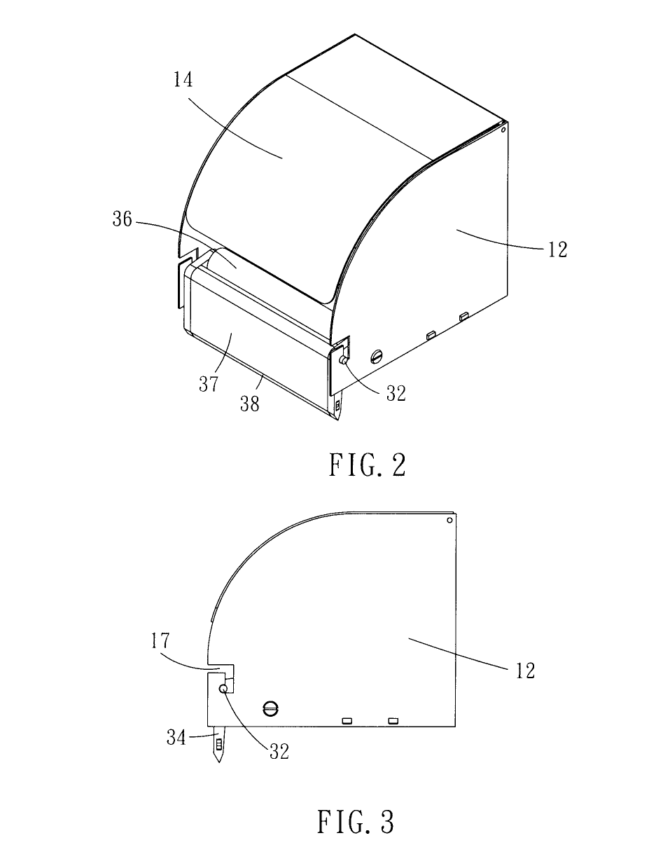

Please refer to FIG. 1 to FIG. 4. The tissue cutting device is adapted for cutting a tissue roll 2 having a rolling section 3 and an extension section 4. The rolling section 3 is disposed about a core 1, and the extension section 4 is extended from one end of the rolling section 3 and has a distal end 5.

The tissue cutting device includes a rack 10, an abutting element 20 and a lever element 30.

The rack 10 includes a back plate 11 and two opposite side plates 12. A supportive plate 13 is disposed between the side plates 12 to support the tissue roll 2 thereon. Preferably, a cover 14 is disposed on the rack 10 to cover the tissue roll 2, preventing the tissue roll 2 from getting wet. In order to install the abutting element 20 and the lever element 30, each side plate 12 is further formed with a combination bore 15, an axial bore 16 and a slot 17, which connects the axial bore 16 and has an open end.

The abutting element 20 is preferably cylindrical shaped, and both ends thereof are fixed in the combination bores 15. In the present embodiment, the abutting element 20 is rotatable with respect to the bores 15, and the abutting element 20 is coated with first soft sleeve, which has a cylindrical abutting surface. In other embodiments of the present invention, the abutting element 20 can be fixedly disposed between the side plates 12 without any soft sleeve coated thereon.

The lever element 30 is rotatable about an axis, and the lever element 30 has a first section and a second section. The second section connects to the first section at the axis. Preferably, the axis is parallel to the abutting element 20. In the present embodiment, the lever element 30 includes L-shaped arms 31, each of which has a laterally protrusive axial knob 32, a first arm section 33 extended from the knob 32 toward the abutting element 20, and a second arm section 34 extended from the knob 32 toward the other direction. The axis is defined between the axial knobs 32, while the knobs 32 are rotatably disposed in the axial bores 16. Further, the knobs 32 can be installed in the axial bores 16 along the slots 17. A rod 35 is disposed between the first arm sections 33, and the rod 35 is parallel to the axis. A second soft sleeve can be rotatably disposed about the rod 35. A plate 37 is disposed between the second arm sections 34. A lower end of the plate 37 is sharpened to form a cutting portion 38. In the present embodiment, the first arm sections 33, the rod 35 and the second soft sleeve 35 co-define the first section, while the second arm sections 34 and the plate 37 co-define the second section. A distal end of the first section, i.e. the rod 35 and the second soft sleeve 36 is referred to as a first end, and a distal end of the second section, i.e. the cutting portion 38, is referred to as a second end.

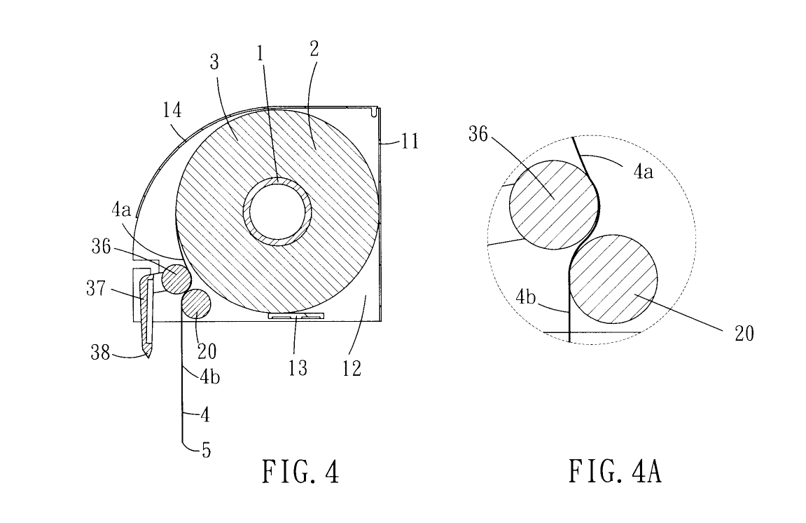

As shown in FIG. 4A, a gap is defined between the abutting element 20 and the first end, or the second soft sleeve 36 more precisely, for the extension section 4 to extend therethrough. Therefore, the extension section 4 is divided into a preserving section 4a and a serving section 4b. The preserving section 4a is between the gap and the rolling section 3, while the serving section 4b is between the gap and the distal end 5.

In the state shown in FIG. 4 and FIG. 4A, the serving section 4b does not apply any force to the second end, thus the user can draw the extension section 4 out freely via the gap.

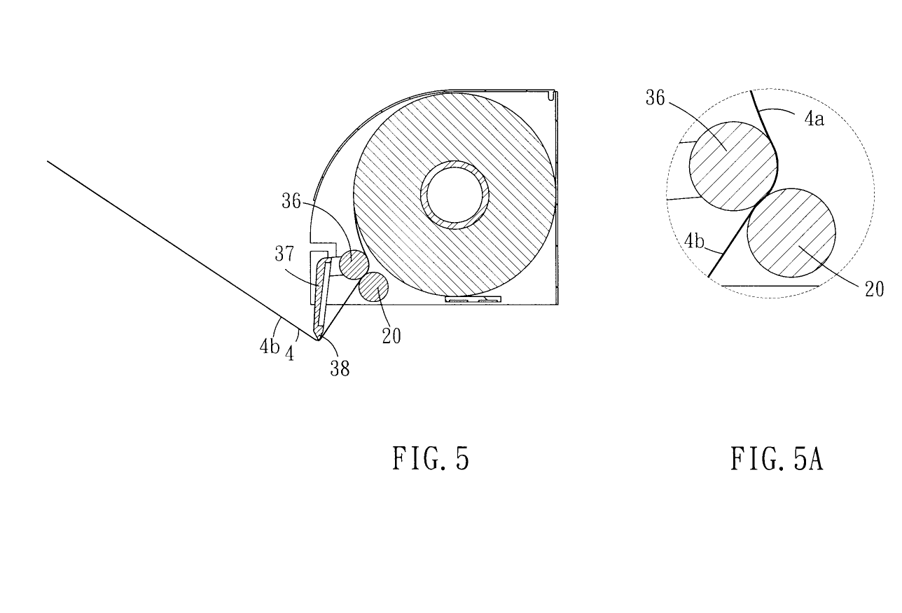

In the state shown in FIG. 5 and FIG. 5A, the serving section 4b is pulled frontward by the user, thus applies force to the second end so as to rotate the section end in a rotary direction, e.g. clockwise as shown in the Figures. As a result, the first end is correspondingly rotated in the rotary direction until the first end, i.e. the second soft sleeve 35, abuts against the abutting element, i.e. the first soft sleeve. As such, the tissue can be clamped between the first end and the abutting element, yet the serving section 4b is stilled pulled with considerable tension, thus the serving section 4b can be cut by the cutting portion 38. Once the serving section 4b is cut, the rest serving section 4b loses the tension and stops apply force to the second end. The lever element 30 is, therefore, returned to its original position, by its own weight or with the help of a resilient member, as shown in FIG. 4. In addition, the rest serving section 4b is downcast by its own weight, thus locates beneath the abutting element 20 for the convenience of the next pull by the user. To provide even bigger abutting strength, the second section of the lever element can be designed to be longer than the first section, so that the second section can have longer force arm.

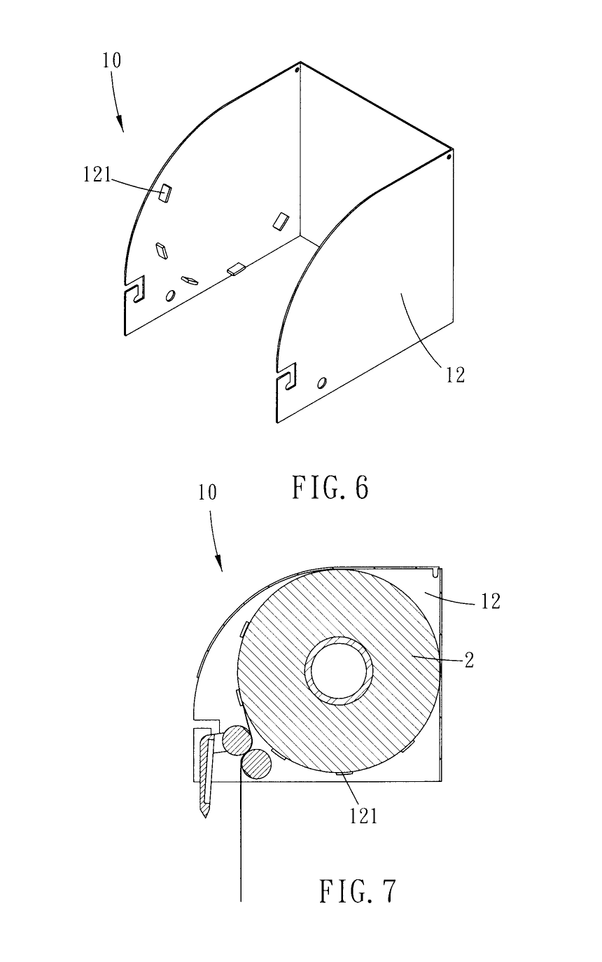

Please refer to FIG. 6 and FIG. 7 for another embodiment of the present invention. The tissue cutting device is similar to the previous embodiment, yet the rack 10 does not include the supportive plate 13 (as shown in FIG. 1). Instead, the inner surfaces of the side plats 12 are formed with several protrusions 121 arranged in an arc shape so as to support the tissue roll.

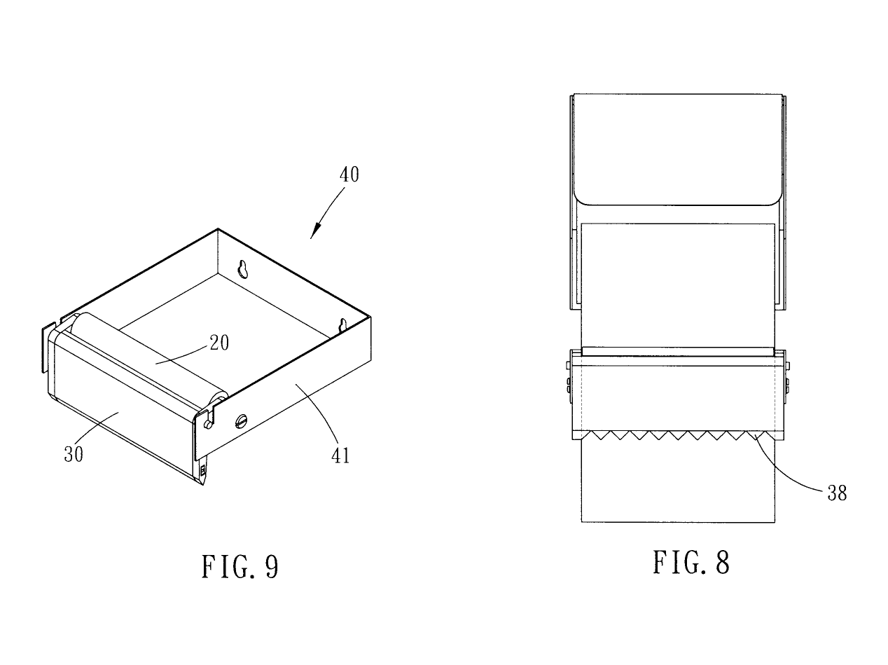

Refer to FIG. 8 for yet another embodiment of the present invention. The cutting portion 38 is teeth shaped to cut the tissue. Yet in other possible embodiments of the present invention, the cutting portion 38 is not sharpened. Instead, the tissue is pre-cut to form multiple lateral cutting lines. As a result, the tissue sections can break along the cutting lines when they bear considerable tension.

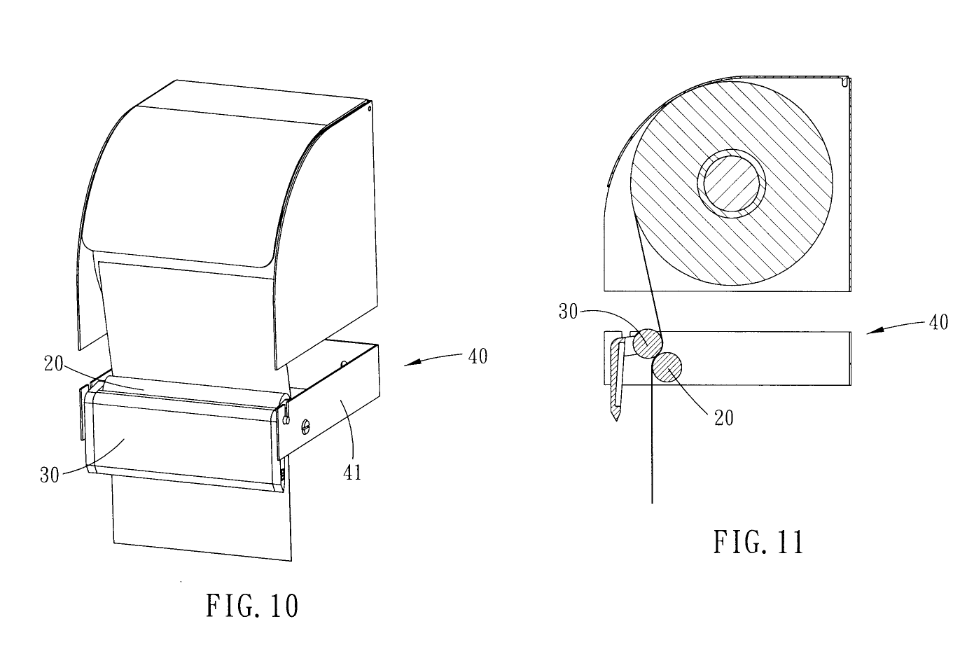

Refer to FIG. 9 to FIG. 11 for yet another embodiment of the present invention. The tissue cutting device includes a rack 40 but is not integrally formed with the tissue holder. The rack 40 includes two opposite arms 41, and the abutting element 20 and the lever element 30 are horizontally disposed therebetween. In the present embodiment, the tissue cutting device can be installed beneath a conventional tissue holder.

It is noted that, with the present tissue cutting device, the user can pull and cut the tissue simply by a single hand. What's more, the tissue will not be further stretched when it is to be cut. Thus the tissue can be cut neatly and easily.

What is claimed is:

1. A tissue cutting device for cutting a tissue roll having a rolling section and an extension section, the rolling section being disposed about a core, the extension section being extended from one end of the rolling section and having a distal end, the tissue cutting device comprising:
an abutting element;
a lever element, being pivotable about an axis, the lever element having a first section and a second section, the second section connecting to the first section at the axis, a distal end of the first section being a first end, a distal end of the second section being a second end;
wherein a gap is defined between the abutting element and the first end for the extension section of the tissue roll to extend therethrough, the extension section is divided into a preserving section and a serving section, the preserving section is between the gap and the rolling section of the tissue roll, the serving section is between the gap and the distal end of the extension section;
wherein when the serving section applies force to the second end so as to rotate the second end in a rotary direction, the first end correspondingly rotates in the rotary direction until the first end abuts against the abutting element, such that the extension section of the tissue roll is clamped between the first end and the abutting element;
wherein when the serving section does not apply force to the second end, the extension section is free to pass through the gap.

2. The tissue cutting device of claim 1, wherein the second section of the lever element is longer than the first section.

3. The tissue cutting device of claim 1, wherein a rod is disposed at the first end of the lever element, the rod is parallel to the axis, a soft sleeve is rotatably disposed about the rod, the soft sleeve is adapted to abut against the abutting element.

4. The tissue cutting device of claim 1, wherein a cutting portion is disposed at the second end of the lever element, when the serving section applies force to the second end, the cutting portion can cut the serving section.

5. The tissue cutting device of claim 1, further comprising a tissue holder to support the tissue roll.

6. The tissue cutting device of claim 1, further comprising a rack, the rack comprising two opposite arms, the abutting element and the lever element being horizontally disposed between the opposite arms.
